(19) United States
(12) Patent Application Publication
(10) Pub. No.: US 2026/0241832 A1
(43) Pub. Date: Aug. 20, 2026

(54) VEHICLE

(71) Applicant: ISUZU MOTORS LIMITED, Yokohama-shi (JP)

(72) Inventor: Kota KATO, Fujisawa-shi (JP)

(21) Appl. No.: 19/444,709

(22) Filed: Jan. 9, 2026

(30) Foreign Application Priority Data
Feb. 20, 2025 (JP) 2025-026017

(51) Int. Cl. B60L 53/80; B60L 50/60

(52) U.S. Cl. CPC B60L 53/80; B60L 50/66

(57) ABSTRACT

A vehicle includes: a pair of side frames; and a mounting portion provided on a side surface of the side frame and to which a replaceable battery is detachably mounted. The mounting portion includes: a rail portion that extends along the longitudinal direction of the side frame and supports the replaceable battery at any position in the longitudinal direction; and a current collector that can be connected to the electrode of the replaceable battery supported by the rail portion.

### CROSS-REFERENCE TO RELATED APPLICATIONS

The present application claims priority to Japanese Patent Applications number 2025-26017, filed on February 20, 2025 contents of which are incorporated herein by reference in their entirety.

### BACKGROUND OF THE INVENTION

The present disclosure relates to a vehicle having a battery. Japanese Unexamined Patent Application Publication No. 2018-167596 discloses a configuration in which a plurality of batteries are detachably mounted in a storage unit fixed to a side frame of a vehicle.

In the above-described vehicle, a plurality of batteries can be mounted at predetermined positions, but when the travel distance is assumed to be short, only some of the plurality of batteries are mounted. When only some of the batteries are mounted, the front-rear weight balance of the vehicle may change, which may adversely affect the travelling performance of the vehicle.

### BRIEF SUMMARY OF THE INVENTION

The present disclosure focuses on this point, and its object is to suppress a change in the weight balance of a vehicle when some of batteries are mounted.

An aspect of the present disclosure provides a vehicle including: a pair of chassis frames; and a mounting portion provided on a side surface of the chassis frame and to which a replaceable battery is detachably mounted, wherein the mounting portion includes: a rail portion that extends along a longitudinal direction of the chassis frame

and is configured to support the battery at any position in the longitudinal direction; and a current collector that can be connected to an electrode of the battery supported by the rail portion.

### BRIEF DESCRIPTION OF THE DRAWINGS

FIG. 1 is a schematic diagram illustrating a vehicle 1 according to one embodiment.

FIG. 2 is a schematic view showing a state in which some of replaceable batteries 13 are mounted on a mounting portion 20.

FIG. 3 is a schematic view for explaining a configuration of the mounting portion 20.

FIG. 4 is a schematic diagram illustrating a mounted state of the mounting portion 20 of the replaceable battery 13.

FIG. 5 is a schematic view for explaining a flow of mounting of the replaceable battery 13 to the mounting portion 20.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of a vehicle

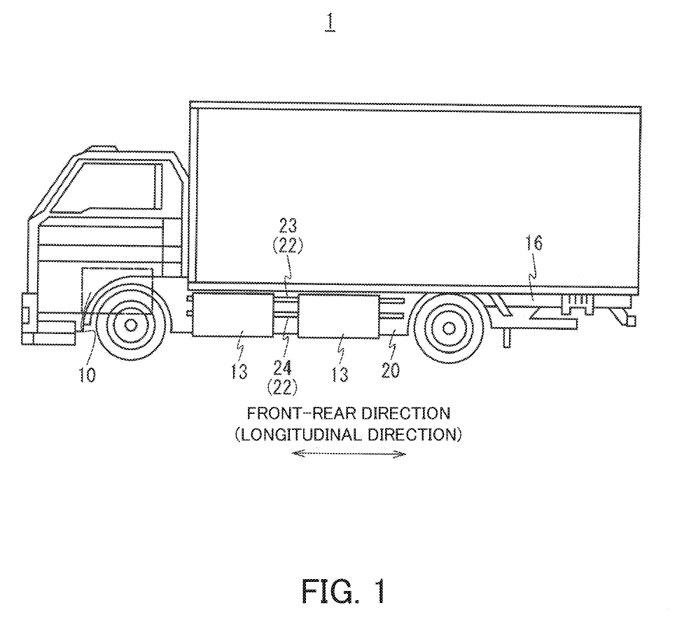

FIG. 1 is a schematic diagram illustrating a vehicle 1 according to one embodiment. The vehicle 1 is an electric vehicle, specifically, a BEV (Battery Electric Vehicle). The vehicle 1 travels by driving a motor using electricity stored in a battery as a power source. Here, the vehicle 1 is a truck having a frame structure. As illustrated in FIG. 1, the vehicle 1 includes a motor 10, a replaceable battery 13, a side frame 16, and a mounting portion 20.

The motor 10 is a drive source that causes the vehicle 1 to travel. The motor 10 generates a driving force to be transmitted to the wheels 12 of the vehicle 1. The motor 10 generates a driving force by receiving electric power from the replaceable battery 13.

The replaceable battery 13 is a battery that can be replaced. The replaceable battery 13 is a secondary battery that can be repeatedly charged. The replaceable battery 13 is, for example, a lithium-ion battery. The replaceable battery 13 can be charged from an external charger. Replacement of the replaceable battery 13 is automatically performed, for example, by a replacement device provided at a replacement station.

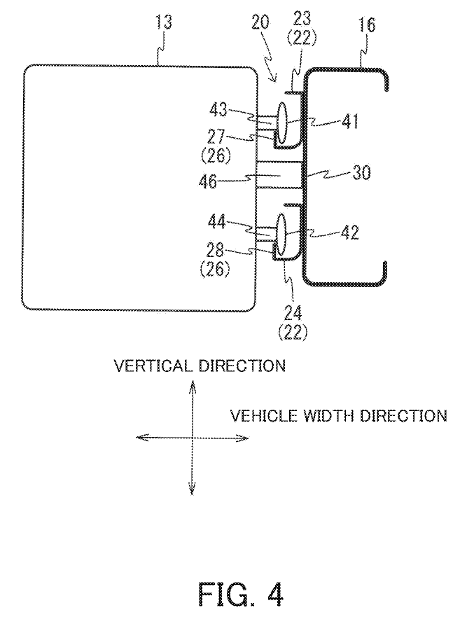

The side frame 16 is a pair of chassis frames forming a frame for supporting the vehicle 1. The side frame 16 has a U-shaped cross-sectional shape (see FIG. 4). The side frame 16 extends along a front-rear direction of the vehicle 1. The motor 10 and the replaceable battery 13 are mounted on the side frame 16. In FIG. 1, the replaceable batteries 13 are mounted on the left side (the front side in FIG. 1) of the side frame 16 in the vehicle width direction, but in practice, the replaceable batteries 13 are also mounted on the right side (the rear side in FIG. 1) of the side frame 16 in the vehicle width direction.

As shown in FIG. 1, the mounting portion 20 is a portion where the replaceable battery 13 is detachably mounted. The mounting portion 20 is provided on the side frame 16. The mounting portion 20 is provided on a side surface of the side frame 16 in a manner to be exposed to the outside, thereby facilitating removal of the replaceable battery 13 from the mounting portion 20 and mounting of the replaceable battery 13 to the mounting portion 20. A plurality of (here, two) replaceable batteries 13 can be mounted on the mounting portion 20.

In FIG. 1, only the mounting portion 20 on the left side of the side frame 16 in the vehicle width direction is shown but in actuality, a mounting portion 20 is also provided on the right side of the side frame 16 in the vehicle width direction. Therefore, four replaceable batteries 13 can be mounted on the vehicle 1 via the two mounting portions 20.

In the vehicle 1, the number of the replaceable batteries 13 mounted on the mounting portion 20 can be changed. For example, when the travel distance of the vehicle 1 is short, only some of the replaceable batteries 13 (for example, two or three replaceable batteries 13) out of four replaceable batteries 13 may be attached to the mounting portion 20. Generally, the front-rear weight balance of the vehicle 1 is adjusted on the assumption that four replaceable batteries 13 are mounted. Therefore, in the case where only some of the replaceable batteries 13 are mounted on the mounting portion 20, the front-rear weight balance of the vehicle 1 may change, which may adversely affect the traveling of the vehicle 1. For example, there is a possibility that the load acting on the front axle of the vehicle 1 and the load acting on the rear axle of the vehicle 1 may differ.

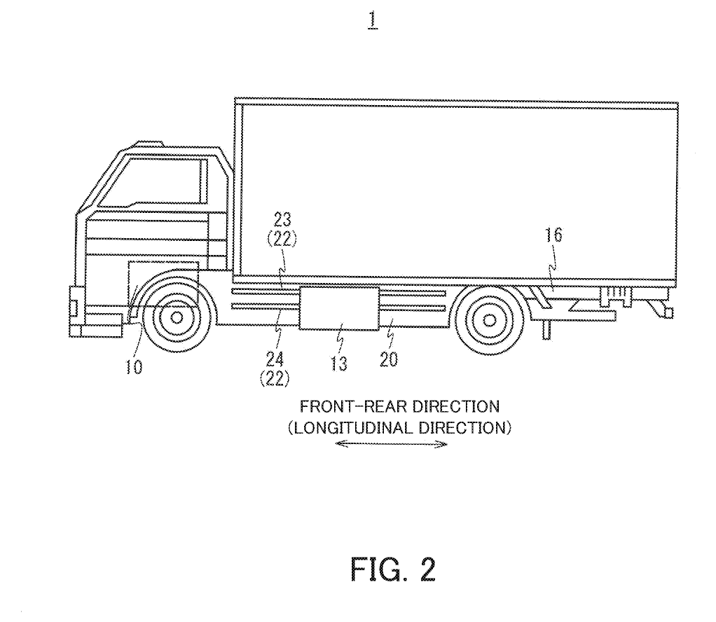

On the other hand, in the vehicle 1 of the present embodiment, in order to suppress a change in weight balance when some of the replaceable batteries 13 are mounted on the mounting portion 20, as shown in FIG. 2, the replaceable battery 13 can be mounted at any position of the mounting portion 20.

FIG. 2 is a schematic diagram illustrating a state in which some of the replaceable batteries 13 are mounted on the mounting portion 20. Here, one replaceable battery 13 is attached to the mounting portion 20 to which two replaceable batteries 13 can be attached. The mounting position, in the front-rear direction, of the replaceable battery 13 is a position where the front-rear weight balance does not change, and is different from the mounting positions, in the front-rear direction, of two replaceable batteries 13 shown in FIG. 1.

### Detailed configuration of the mounting portion

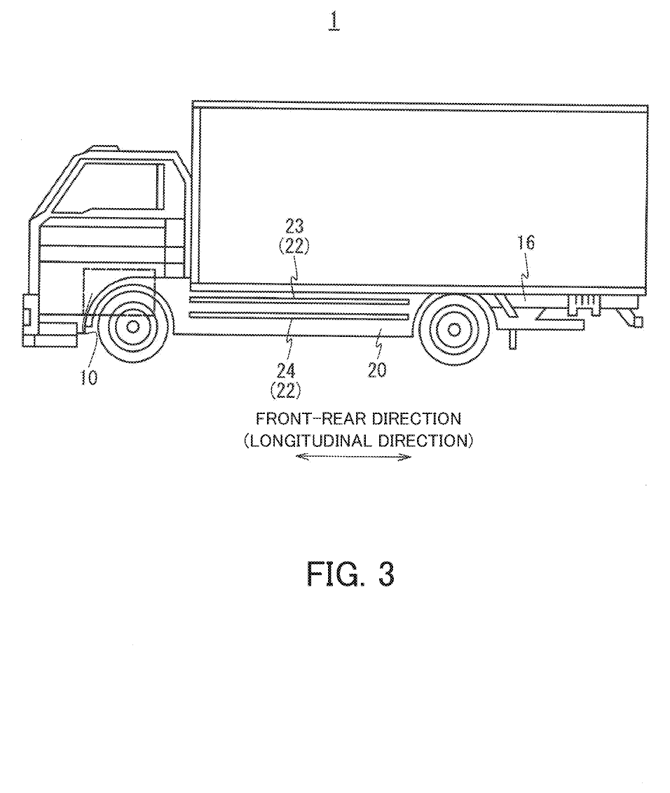

A detailed configuration of the mounting portion 20 will be described with reference to FIGS. 3 and 4.

FIG. 3 is a schematic view for explaining the configuration of the mounting portion 20. FIG. 4 is a schematic diagram illustrating a mounted state of the mounting portion 20 of the replaceable battery 13. The mounting portion 20 includes a rail portion 22, a current collector 26, and a fixing portion 30.

The rail portion 22 extends along the longitudinal direction of the side frame 16 (in other words, the front-rear direction of the vehicle 1). Specifically, the rail portion 22 extends along the longitudinal direction on the side surface of the side frame 16, between the front wheel and the rear wheel of the vehicle 1. The rail portion 22 supports the replaceable battery 13 at any position in the longitudinal direction. Specifically, the rail portion 22 supports the replaceable battery 13 at a position that suppresses a change in the weight balance of the vehicle 1 in the longitudinal direction.

The rail portion 22 supports the replaceable battery 13 at any position in the longitudinal direction when a single replaceable battery 13 is mounted. As a result, it becomes easier to adjust the replaceable battery 13 to be newly mounted to any position in the front-rear direction of the vehicle 1. Specifically, the replacement device provided at the replacement station can more easily mount the replaceable battery 13 to a desired position along the rail portion 22.

The rail portion 22 supports a roller provided in the replaceable battery 13 in a manner to be movable in the longitudinal direction. By moving the roller of the replaceable battery 13 in the longitudinal direction, it becomes easier to adjust the replaceable battery 13 to any position in the longitudinal direction. In particular, by moving the replaceable battery 13 supported by the rail portion 22 in the longitudinal direction via the roller, the replaceable device can more easily perform fine adjustment of the position of the replaceable battery 13 in the longitudinal direction.

As shown in FIG. 4, the replaceable battery 13 includes a first roller 41 and a second roller 42. The first roller 41 is rotatably supported by a first support portion 43. The second roller 42 is rotatably supported by a second support portion 44. The first support portion 43 and the second support portion 44 protrude from the side surface of the replaceable battery 13. The first support portion 43 and the second support portion 44 are spaced apart by a predetermined interval in the vertical direction. The first roller 41 is supported by a distal end of the first support portion 43, and the second roller 42 is supported by a distal end of the second support portion 44. The first roller 41, the second roller 42, the first support portion 43, and the second support portion 44 are made of, for example, metal.

The rail portion 22 includes a first rail portion 23 and a second rail portion 24 that are spaced apart by a predetermined interval in the vertical direction. The first rail portion 23 is located above in the vertical direction, and the second rail portion 24 is located below in the vertical direction. The length of the first rail portion 23 in the longitudinal direction is the same as the length of the second rail portion 24 in the longitudinal direction. The cross-sectional shape of the first rail portion 23 is the same as the cross-sectional shape of the second rail portion 24 as shown in FIG. 4.

The first rail portion 23 supports the first roller 41 provided in the replaceable battery 13 in a manner to be movable in the longitudinal direction. The second rail portion 24 supports the second roller 42 provided in the replaceable battery 13 in a manner to be movable in the longitudinal direction. By having the first rail portion 23 and the second rail portion 24 support the first roller 41 and the second roller 42, the replaceable battery 13 can be more easily supported in a stable state. In addition, the first roller 41 and the second roller 42 move together in the longitudinal direction, allowing the position of the replaceable battery 13 along the longitudinal direction to be more easily adjusted without altering its orientation.

The rail portion 22 may support a plurality of replaceable batteries 13 at any position in the longitudinal direction. For example, in order to adjust the interval in the longitudinal direction between two replaceable batteries 13 shown in FIG. 1, the first rail portion 23 and the second rail portion 24 support the two replaceable batteries 13 at any position (specifically, at a position that suppresses a change in the weight balance of the vehicle 1 in the longitudinal direction) in the longitudinal direction. As one example, the replacement device may adjust the interval in the longitudinal direction between the two exchangeable batteries 13 in accordance with the state of the vehicle 1’s load (for example, the position of the load).

The current collector 26 is a portion connected to an electrode of the replaceable battery 13 supported by the rail portion 22. Accordingly, electric power can be supplied to the motor 10 from the replaceable battery 13 supported by the rail portion 22. The electrode of the replaceable battery 13 is provided, for example, on the first roller 41 and the second roller 42.

The current collector 26 is provided on the rail portion 22. Specifically, the current collector 26 is formed along the longitudinal direction on the surface (specifically, the inner surface) of the rail portion 22. Accordingly, even when the position of the replaceable battery 13 in the longitudinal direction is adjusted along the rail portion 22, it becomes easier to connect the electrode of the replaceable battery 13 and the current collector 26.

In the present embodiment, the current collector 26 includes a first current collector 27 and a second current collector 28. The first current collector 27 is provided on the first rail portion 23, and the second current collector 28 is provided on the second rail portion 24. The first rail portion 23 is connected to a first electrode (e.g., a positive electrode) of the replaceable battery 13, and the second rail portion 24 is connected to a second electrode (e.g., a negative electrode) of the replaceable battery 13. The first electrode of the replaceable battery 13 is provided on the first roller 41, and the second electrode is provided on the second roller 42. Accordingly, even when the position of the replaceable battery 13 is adjusted, the first electrode and the second electrode of the replaceable battery 13 can be appropriately connected.

The fixing portion 30 serves to fix the position of the roller of the replaceable battery 13 in the longitudinal direction relative to the rail portion 22. The fixing portion 30 extends along the longitudinal direction on the side surface of the side frame 16. Specifically, the fixing portion 30 is provided between the first rail portion 23 and the second rail portion 24 in the vertical direction. Accordingly, even when the first rail portion 23 and the second rail portion 24 support the replaceable battery 13, it becomes easier to appropriately connect the first electrode and the second electrode of the replaceable battery 13 to the first current collector 27 of the first rail portion 23 and the second current collector 28 of the second rail portion 24.

The fixing portion 30 fixes the longitudinal positions of the first roller 41 and the second roller 42 of the replaceable battery 13 by engaging with an engaging portion 46 provided in the replaceable battery 13. The engaging portion 46 is a projection protruding from the side surface of the replaceable battery 13. The engaging portion 46 is located between the first support portion 43 and the second support portion 44 in the vertical direction. The engaging portion 46 is movable between a standby position, which is where it is located before an engagement, and an engagement position at which it engages with the fixing portion 30. The fixing portion 30 is, for example, a recessed portion formed on the side surface of the side frame 16, and engages with a distal end portion of the engaging portion 46 located at the engaging position. The recessed portion serving as the fixing portion 30 is a groove formed along the longitudinal direction of the side frame 16. Accordingly, the first roller 41 and the second roller 42 can be easily fixed at any position in the longitudinal direction.

Although the rail portion 22 includes the first rail portion 23 and the second rail portion 24 in the above description, the present disclosure is not limited thereto. For example, the rail portion 22 may include only the first rail portion 23, and the first current collector 27 and the second current collector 28 may be provided on the first rail portion 23.

### Flow of mounting the replaceable battery

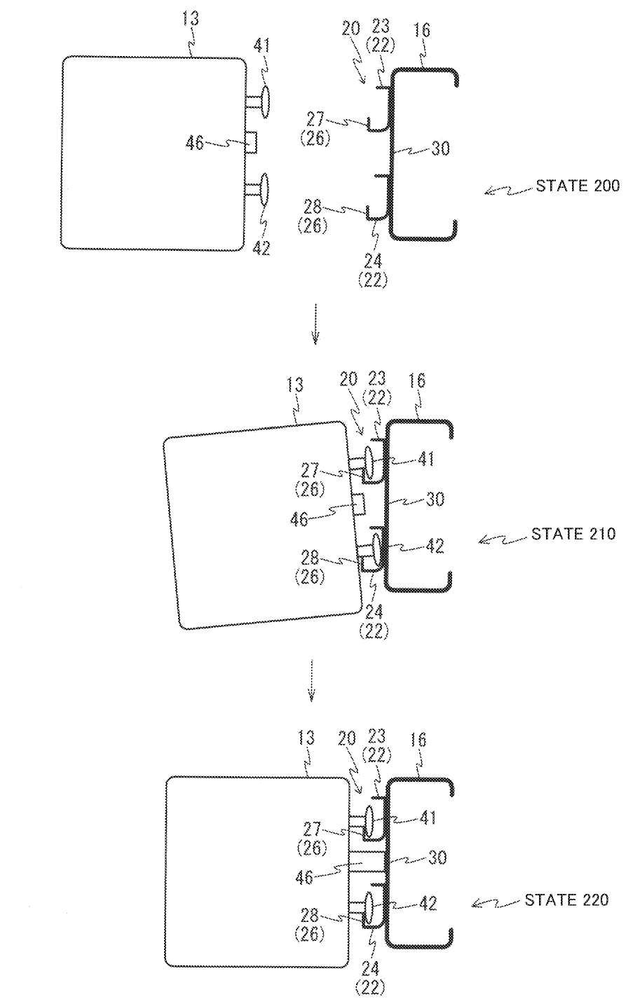

FIG. 5 is a schematic view for explaining mounting of the replaceable battery 13 to the mounting portion 20. Here, the mounting of the replaceable battery 13 to the mounting portion 20 is performed automatically by the replacing device.

First, the replacement device brings the replaceable battery 13 toward the mounting portion 20 (state 200). For example, the replacement device brings the replaceable battery 13 toward the mounting portion 20 while supporting the replaceable battery 13 with an arm or the like (not shown). At this time, the replacement device positions the replaceable battery 13 at a desired position (a position where the weight balance is stabilized) in the front-rear direction of the vehicle 1. It should be noted that the desired position is set in advance according to the number of replaceable batteries 13 to be mounted.

Next, the replacement device inserts the roller of the replaceable battery 13 into the rail portion 22. Specifically, the replacement device inserts the first roller 41 into the first rail portion 23, and inserts the second roller 42 into the second rail portion 24 (state 210). At this time, the replaceable battery 13 is inclined so that the first roller 41 can be easily inserted into the first rail portion 23 and the second roller 42 can be easily inserted into the second rail portion 24.

Next, the replacement device causes the engaging portion 46 of the replaceable battery 13 to protrude, thereby engaging the engaging portion 46 with the fixing portion 30 (state 220). Specifically, by having the engaging portion 46 move from the standby position (the position shown in the state 210) to the engaging position (the position shown in the state 220), the exchanging device causes the distal end portion of the engaging portion 46 to engage with the recessed portion, which is the fixing portion 30. In this manner, the first roller 41 and the second roller 42 do not rotate, and the position of the replaceable battery 13 in the longitudinal direction is fixed.

When the engaging portion 46 engages with the fixing portion 30, the orientation of the replaceable battery 13 becomes parallel to the horizontal plane, and the first roller 41 is supported by the first rail portion 23 and the second roller 42 is supported by the second rail portion 24 (state 220). Accordingly, the first electrode of the replaceable battery 13 is connected to the first current collector 27 of the first rail portion 23 and the second electrode of the replaceable battery 13 is connected to the second current collector 28 of the second rail portion 24.

### Effects of the Embodiment

The vehicle 1 of the above-described embodiment includes: the mounting portion 20 provided on the side surface of the side frame 16 and to which the replaceable battery 13 is detachably mounted. The mounting portion 20 includes: the rail portion 22 that supports the replaceable battery 13 at any position in the longitudinal direction, and the current collector 26 that can be connected to the electrode of the replaceable battery 13 supported by the rail portion 22. Accordingly, in the state where the replaceable battery 13 is positioned at a position where the weight balance of the vehicle 1 in the longitudinal direction does not change, the current collector 26 can be connected to the electrode of the replaceable battery 13.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A vehicle comprising:
a pair of chassis frames; and
a mounting portion provided on a side surface of the chassis frame and to which a replaceable battery is detachably mounted, wherein the mounting portion includes:
a rail portion that extends along a longitudinal direction of the chassis frame and is configured to support the battery at any position in the longitudinal direction; and
a current collector that can be connected to an electrode of the battery supported by the rail portion.

2. The vehicle according to claim 1, wherein the current collector is provided on the rail portion.

3. The vehicle according to claim 1, wherein a plurality of the batteries can be mounted on the mounting portion, and
the rail portion supports, when some of the plurality of batteries are mounted, the battery at a position that suppresses a change in weight balance of the vehicle in the longitudinal direction.

4. The vehicle according to claim 1, wherein a plurality of the batteries can be mounted on the mounting portion, and
when all of the plurality of batteries are mounted, the rail portion supports the batteries at a position that suppresses a change in weight balance of the vehicle in the longitudinal direction.

5. The vehicle according to claim 4, wherein the rail portion supports the plurality of batteries at any position in the longitudinal direction so that an interval in the longitudinal direction between the plurality of batteries can be adjusted.

6. The vehicle according to claim 1, wherein the rail portion supports a roller provided on the battery in a manner to be movable in the longitudinal direction.

7. The vehicle according to claim 1, wherein the rail portion includes a first rail portion and a second rail portion which are spaced apart from each other by a predetermined interval in a vertical direction,
the first rail portion supports a first roller provided on the battery in a manner to be movable in the longitudinal direction, and
the second rail portion supports a second roller provided on the battery in a manner to be movable in the longitudinal direction.

8. The vehicle according to claim 7, wherein the first rail portion includes a first current collector connectable to a first electrode of the battery, and
the second rail portion includes a second current collector connectable to a second electrode of the battery.

9. The vehicle according to claim 6, further comprising:
a fixing portion that fixes a position of the roller in the longitudinal direction relative to the rail portion.

10. The vehicle according to claim 9, wherein the rail portion includes a first rail portion and a second rail portion which are spaced apart from each other by a predetermined interval in a vertical direction, and
the fixing portion is located between the first rail portion and the second rail portion in the vertical direction.
